(19) United States
(12) Patent Application Publication
(10) Pub. No.: US 2004/0193730 A1
(43) Pub. Date: Sep. 30, 2004

(54) Method and computer programs for providing special processing of a communication sent across a communication network

(76) Inventor: Stephen K. Vernon, Columbia, MD (US)

Correspondence Address: Northrop Grumman Space & Mission Systems Corp., Intellectual Asset Management, One Space Park, R11/2796, Redondo Beach, CA, 90278, US

(21) Appl. No.: 10/397,937

(22) Filed: Mar. 25, 2003

(51) Int. Cl. G06F 15/16; G06F 15/173

(52) U.S. Cl. 709/245; 709/238

(57) ABSTRACT

A router (101, 102) at a first location (161) is programmed (306) to route a communication to a first special processor (141), when an address of a second user processor (121) to which the communication is sent is in a special address range. The first special processor is programmed (308) to perform special processing on the communication and to perform one of encapsulating and re-addressing the communication to send the communication to a second special processor (142), the second special processor having an address that is not in the special address range, thereby allowing routine delivery of the communication to the second special processor. The second special processor is programmed (310) to perform inverse special processing on the communication, and to perform one of unencapsulating and re-addressing the communication allowing routine delivery of the communication to the second user processor.

### STATEMENT REGARDING FEDERAL SPONSORSHIP

This invention was made with government support under Worldwide Systems Support Contract, MDA904-97-C-0613, awarded by Maryland Procurement Office. The government has certain rights in this invention.

### FIELD OF THE INVENTION

This invention relates in general to communication networks, and more specifically to a method and computer programs for providing special processing of a communication sent across a communication network.

### BACKGROUND OF THE INVENTION

In selected cases, it is desirable to apply special processing, such as protocol translation, encryption, or bandwidth management to network traffic that crosses a Wide Area Network (WAN), such as the Internet. In prior-art systems, interception of selected IP packets has been accomplished by passing all traffic through a common special processor to process the packets requiring special processing, while sending the packets not requiring special processing through transparently. A problem with the prior-art method is that the special processor must handle the processed traffic plus transport the non-processed traffic. This places a heavy processing burden on the special processor, as well as creating a single point of failure for all traffic. Other disadvantages include requiring a technique to select the packets to be processed (such as a configuration file), placing constraints on the network architecture, and imposing a need to scale the special purpose processor to handle the traffic load.

Thus, what is needed is a method and computer programs for providing special processing of a communication sent across a communication network. The method and computer programs preferably will provide reliable special processing of selected traffic without requiring all traffic to pass through the special processor and without incurring the other disadvantages of the prior-art methods.

### SUMMARY OF THE INVENTION

An object of the present invention is to make available a method in a communication system for providing a special processing of a communication sent from a first user processor at a first location to a second user processor at a second location across a communication network, the second user processor having an address in a special address range assigned to user processors in the second location that require the special processing. The method includes programming a router at the first location to route the communication to a first special processor, in response to the address of the second user processor being in the special address range; and programming the first special processor to perform the special processing on the communication addressed to the second user processor and to perform one of encapsulating and re-addressing the communication to send the communication to a second special processor, the second special processor having an address that is not in the special address range, thereby allowing routine delivery of the communication to the second special processor.

Another object of the present invention is to make available a computer program for programming a special processor in a communication system for providing a special processing of a communication sent from a first user processor at a first location to a second user processor at a second location across a communication network, the second user processor having an address in a special address range assigned to user processors in the second location that require the special processing. The computer program includes a first software element for programming the special processor to receive the communication addressed to the second user processor; and a second software element for programming the special processor to perform the special processing on the communication, in response to receiving the communication addressed to the second user processor, and to perform one of encapsulating and re-addressing the communication, and then to routinely deliver the communication to a second special processor, the second special processor having an address that is not in the special address range.

A third object of the present invention is to make available a computer program for programming a router in a communication system for providing a special processing of a communication sent from a first user processor at a first location to a second user processor at a second location across a communication network, the second user processor having an address in a special address range assigned to user processors in the second location that require the special processing. The computer program comprises a first software element for programming the router at the first location to route the communication to a first special processor, in response to the address of the second user processor being in the special address range.

Additional objects, advantages, and features of the present invention will become apparent from the following description and appended claims, taken in conjunction with the accompanying drawings.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 is an electrical block diagram of an exemplary first embodiment of a communication system.

FIG. 2 is an electrical block diagram of an exemplary second embodiment of a communication system.

FIG. 3 is a flow diagram depicting operations for sending a communication from a first location to a second location.

FIG. 4 is a diagram depicting software elements of a computer program for a special processor.

FIG. 5 is a diagram depicting software elements of a computer program for a router.

### DETAILED DESCRIPTION OF THE INVENTION

In overview form the present disclosure concerns communication networks. More particularly, various inventive concepts and principles embodied as a method and computer programs for providing special processing of a communication sent across a communication network will be discussed and disclosed. The communication networks and devices of particular interest are those being deployed and developed for use with wide area networks, such as the Internet, although the concepts and principles have application in other networks and devices as well.

The instant disclosure is provided to further explain in an enabling fashion the best modes of making and using various embodiments in accordance with the present invention. The disclosure is further offered to enhance an understanding and appreciation for the inventive principles and advantages thereof, rather than to limit the invention in any manner. The invention is defined solely by the appended claims including any amendments made during the pendency of this application and all equivalents of those claims as issued.

It is further understood that the use of relational terms, if any, such as first and second, top and bottom, and the like are used solely to distinguish one from another entity or action without necessarily requiring or implying any actual such relationship or order between such entities or actions. Much of the inventive functionality and many of the inventive principles are best implemented with processors and integrated circuits (ICs) such as custom or application-specific ICs. It is expected that one of ordinary skill, notwithstanding possibly significant effort and many design choices motivated by, for example, available time, current technology, and economic considerations, when guided by the concepts and principles disclosed herein will be readily capable of programming such processors and generating such ICs with minimal experimentation. Therefore, in the interest of brevity and minimization of any risk of obscuring the principles and concepts according to the present invention, further discussion of such processors and ICs, if any, will be limited to the essentials with respect to the principles and concepts employed by the preferred embodiments.

In accordance with the present invention, a method is provided for performing transparent special processing of IP traffic between selected systems across a Wide Area Network (WAN) such as the Internet. The special processing is transparent in the sense that user processors do not require any modifications to utilize the special processing and may not be aware of the special processing. A typical network scenario consists of a number of locations, each containing a number of user processors, connected by a WAN. In selected cases, it is desirable to apply special processing, such as protocol translation, encryption, or bandwidth management to network traffic that crosses the WAN. A scaleable method is provided to select and intercept the desired IP traffic while allowing the non-selected traffic to bypass the special processors. This method is scaleable in that large sites can use multiple ingress/egress routers to handle the traffic load while ensuring all special traffic is intercepted. This method also provides the ability to use different special processors for each remote location so that the processing load is distributed across multiple processors.

Implementation preferably starts with designation of the user processors at each location that require special processing across the WAN between the locations. Once the user processors requiring special processing are designated, the IP address range of the location must be divided into two segments. The first IP address range is assigned to user processors that do not require special processing, while the other IP address range (referred to herein below as the “special address range”) is assigned to user processors that do require special processing across the WAN. The size of each IP address range is adjustable based on the number of user processors at the location requiring special processing. The special address range can be as small as to include only a single processor or as large as to include all user processors at the location. The special processor is assigned an address that is not in the special address range. Each location requiring special processing should connect the special processor directly (usually via a single LAN segment) to all site ingress/egress routers. The direct connection is utilized, because all ingress/egress routers must be able to statically route IP traffic to the special processor. Connection to all the location's ingress/egress routers ensures that traffic cannot bypass the special processing selection process. When all user processors requiring special processing have their assigned special-range IP address and the special processors are installed, the final steps are to configure the static routes in the ingress/egress routers and configure the special processors.

The ingress/egress router static route intercepts WAN special processing traffic and routes the traffic to the local special processor. The static routes are designed to intercept IP packets that are addressed to a remote user processor in the remote location's special address range. The local special processor performs the required special processing on the intercepted data and then re-addresses or encapsulates the data so that the network will routinely deliver it to the special processor at the remote location. The remote location special processor performs the inverse processing and then re-addresses or unencapsulates the data to forward it to the remote user processor using its original IP address.

In the opposite direction, the remote user processor return IP traffic is intercepted by the remote location ingress/egress router static route and routed to the remote location's special processor. This is similar to the forward traffic intercept function, providing the special processors access to both the forward and reverse IP traffic. The remote location special processor performs the required special processing then re-addresses or encapsulates the data so the network will deliver it back to the originating location special processor. The originating local special processor applies the inverse processing on the reverse direction IP data then re-addresses or unencapsulates the data so the network will routinely deliver the data back to the local user processor.

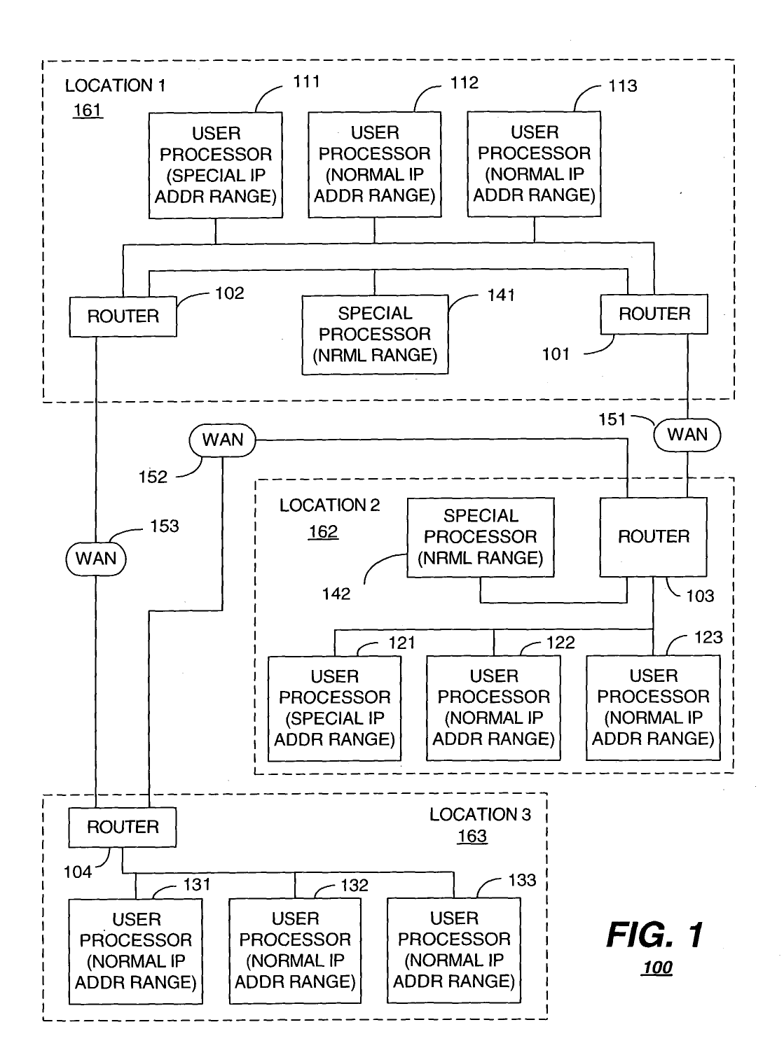

FIG. 1 is an electrical block diagram of an exemplary first embodiment 100 of a communication system in accordance with the present invention. The first embodiment 100 depicts three locations 161, 162, 163 each containing three user processors connected by three Wide Area Network (WAN) circuits 151, 152, 153. Special processing is required for all network traffic between Location 1 user processor 111 and Location 2 processor 121. The IP address space at locations 1 and 2 is partitioned into a special processing segment IP address range (the special address range) and a normal processing segment IP address range. The systems requiring special processing have IP addresses in the special address range while all other systems including the special processors 141, 142 are assigned IP addresses in the normal processing IP address range. The requirement is to pass all traffic requiring special processing to the special processors 141, 142. This is accomplished by installing static routes in the location's ingress/egress routers as follows. All traffic from location 1 system 111 to location 2 system 121 normally passes through ingress/egress router 101. Since the traffic requires special processing, a static route is installed in router 101 that diverts the special processing traffic to special processor 141 based on the destination IP address of remote processor 121, which is in the location 2 special address range. The intercepted traffic is re-addressed or encapsulated after compression, encryption, protocol conversion or other special processing by special processor 141. The re-addressed or encapsulated traffic is then forwarded to special processor 142 via normal network routing. Special processor 142 receives the traffic and applies the reverse special processing then re-addresses or un-encapsulates the data so that normal network routing sends the traffic through router 103 to location 2 system 121. The return response from location 2 system 121 proceeds to site router 103 where a static route forwards the data to location 2 special processor 142. The special processor 142 applies the special processing to the traffic then forwards the re-addressed or encapsulated traffic directly to location 1 special processor 141 via normal network routing. The special processor 141 applies inverse special processing to the return traffic and then re-addresses or un-encapsulates the data. Normal network routing then transports the return traffic from the special processor 141 to the location 1 processor 111.

It is important to note what is not impacted by the special processing capability. All traffic within location 1 between system 111 and systems 112 and 113 is routed normally within the location, and the local traffic does not pass through special processor 141. The same is true for all traffic within location 2. Also, all traffic between location 1 and location 3 automatically bypasses the special processor 141 using normal network routing. All traffic between location 2 and location 3 bypasses the special processor 142. Advantageously, the special processors 141, 142 only receive the traffic that requires the special processing.

A second important point is what happens when the link via WAN 151 fails. The traffic between location 1 and location 2 would normally be rerouted through location 3 to bypass the WAN failure through normal network rerouting capabilities. The special processing traffic will exit location 1 through router 102 instead of router 101, which is normally used. Special processor 141 still receives the traffic, because the same static route supporting the special processor in router 101 is also configured in router 102. This advantageously provides coverage for all the location ingress/egress paths, without requiring the traffic to pass through a single path. The distributed intercept capability improves network reliability and reduces the load at any single network ingress/egress path, thus supporting scaling. The traffic between special processors 141 and 142 will communicate through routers 102, 103, and 104 during the network failure using standard network routing protocols to route around the failure.

The specific routing protocol (RIP, OSPF, BGP, etc.) used within each location and across the WAN is not restricted by this method. The only protocol requirement is that the location ingress/egress routers support static routes and are able to handle the traffic load. It is believed that virtually all commercially available routers currently support a static routing capability.

There are two cross-address scenarios that need to be noted. The first cross-address scenario occurs when a user processor with a local special processing IP address segment initiates a connection to a remote location processor with a normal segment IP address. Referring again to FIG. 1, an example would be processor 111 attempting to connect to processor 122. In this scenario, the IP traffic to the remote location will bypass the local special processor 141, while the return traffic will be routed through the remote location special processor 142. This type of routing leads to a special processing failure unless additional steps are taken to handle it. The cross-route situations can be recognized by the traffic source and destination IP address thus allowing action to be taken in real time by the special processors 141, 142. Processing options include rejecting the traffic, or transparently tunneling the traffic in the single direction captured (no special processing is possible).

The opposite cross-address scenario where a local user processor with a normal segment IP address connects to a remote location user processor with an IP address in the special address range. In FIG. 1, an example would be a processor 112 connection to processor 121. This cross-address scenario can also be detected in real time. The forward IP traffic is routed to the local special processor 141, but the return traffic goes directly to the local location user processor 112. This has the same processing options of rejecting the traffic, or transparently tunneling the traffic in the reverse direction (again, no special processing possible). In addition, it can support a non-transparent connect. A non-transparent connect is provided when the IP data exiting from the local special processor 141 has the local special processor 141 as its return address (and thus the processing is no longer transparent).

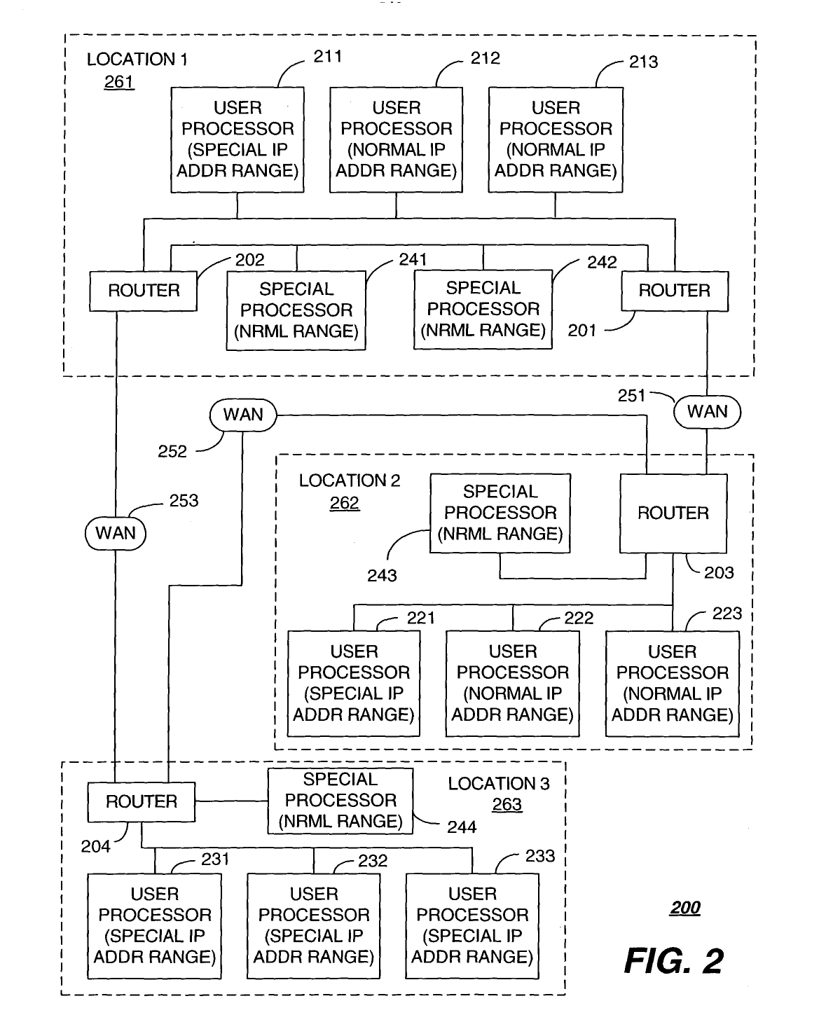

The first embodiment 100 demonstrates scaling capability via limited traffic selection for a large location with multiple ingress/egress routers. Another scaling capability is illustrated in FIG. 2, an electrical block diagram of an exemplary second embodiment 200 of a communication system in accordance with the present invention. The second embodiment 200 depicts another three-location scenario with each location 261, 262, 263 having at least one user processor requiring special processing between locations. The same design with designated IP address segments and static routes applies to this scenario. All the user processors 231, 232, 233 at location 3 are within the special processing IP address segment. The scaling capabilities in this scenario come from the dual special processors 241 and 242 at location 1. Special processor 241 preferably handles the traffic between locations 1 and 2, while special processor 242 preferably handles the IP traffic between locations 1 and 3. This is accomplished by proper setting of the static routes in routers 201 and 202. The traffic exiting location 1 to the special processing IP address range segment at location 2 is routed to special processor 241 via the destination in the static route in routers 201 and 202. The traffic exiting location 1 to the special processing IP address segment at location 3 is routed to special processor 242 via the destination of the static route in routers 201 and 202. Using the static route destination IP address supports multiple special processors, thus advantageously distributing the processing load as necessary.

The above approaches use static routes, but, alternatively, it is possible to use special processors that can automatically set the routes in the routers. This would require the special processors to understand the specific routing protocol in use and to directly interface with the routing protocol. This would not be as easy but could be desirable in certain circumstances.

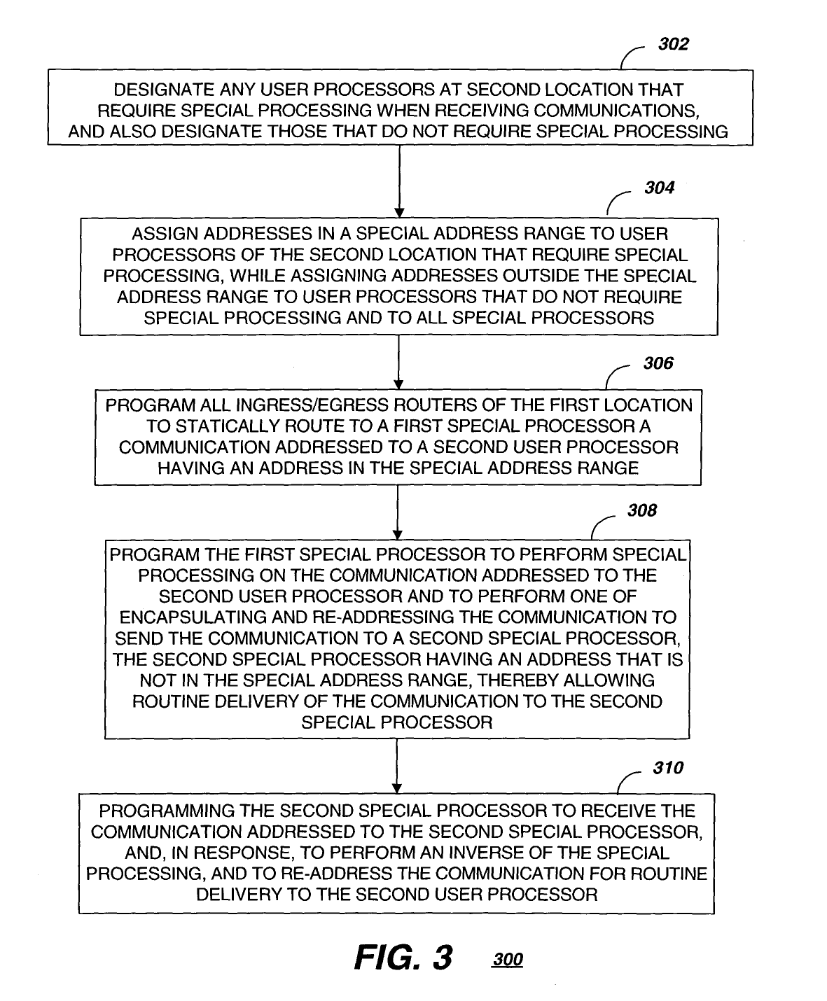

Referring to FIG. 3, a flow diagram 300 depicting operations for sending a communication from a first location to a second location in accordance with the present invention begins with designating 302 any user processors at the second location that require special processing when receiving communications, and also designating those that do not require special processing. The next step is assigning addresses 304 in the special address range to the user processors that require the special processing, and assigning addresses outside the special address range to the user processors that do not require the special processing and to all special processors of the second location.

The next step is programming 306 all ingress/egress routers of the first location to statically route to a first special processor a communication addressed to a second user processor having an address in the special address range. The first special processor is programmed 308 to perform special processing on the communication addressed to the second user processor and to perform one of encapsulating and re-addressing the communication to send the communication to a second special processor, the second special processor having an address that is not in the special address range, thereby allowing routine delivery of the communication to the second special processor. The second special processor is programmed 310 to receive the communication addressed to the second special processor, and, in response, to perform an inverse of the special processing, and to re-address the communication for routine delivery to the second user processor.

It will be appreciated that when the first location includes a plurality of ingress/egress routers, the plurality of ingress/egress routers are all coupled directly to the first special processor. In addition, the plurality of ingress/egress routers are all programmed to route the communication to the first special processor, in response to the address of the second user processor being in the special address range.

In one embodiment, the first location includes a plurality of special processors, and the second location includes a plurality of groups of user processors requiring special processing, the plurality of groups having addresses in a corresponding plurality of special-ranges. In that embodiment, the router is programmed to route a message addressed to a user processor in one of the plurality of groups to one of the plurality of special processors assigned to handle the one of the plurality of groups.

In another embodiment, the communication system includes a third location having a third user processor having its address in a second special address range assigned to user processors in the third location that require the special processing, and the first location includes first and second special processors. In this embodiment, the router preferably is programmed to route to the first special processor all messages addressed to the second user processor in the second location, and is further programmed to route to the second special processor all messages addressed to the third user processor in the third location.

It will be further appreciated that the router is preferably programmed to route all communications from a first user processor in the first location to another user processor in the first location, such that no special processor is involved in the communications, and to route all communications from the first user processor to another user processor in the second location whose address is outside the special address range, such that no special processor is involved in the communications.

It will also be appreciated that one of the special processors can apply an exception during a cross-address situation in which a user processor that does not require the special processing makes an attempt to communicate across the communication network with another user processor that does require the special processing. The exception is preferably selected from a group of exceptions consisting of: (a) rejecting the attempt to communicate; (b) transparently tunneling the attempt to communicate, without the special processing; and (c) non-transparently connecting the attempt to communicate (e.g., by replacing the sender's address with the address of the special processor).

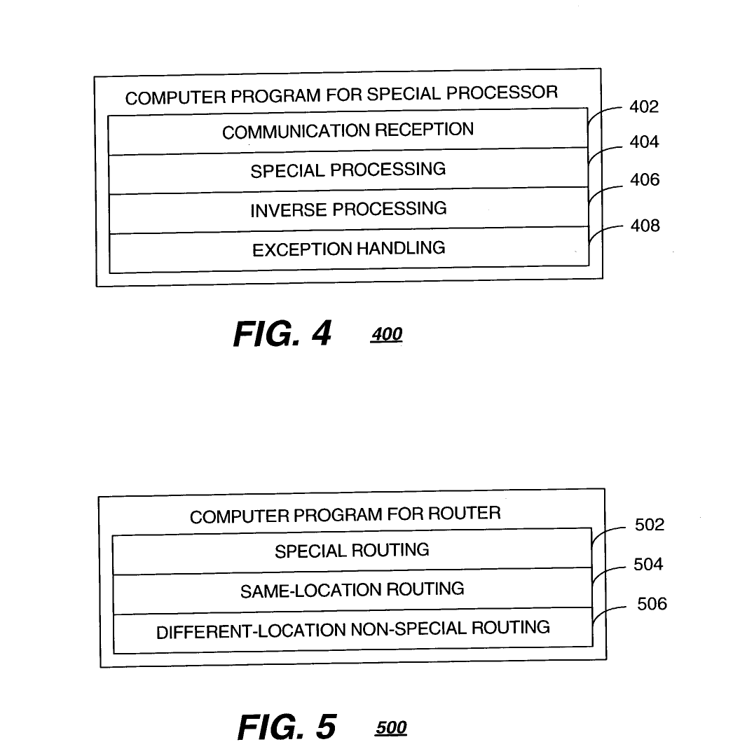

Referring to FIG. 4, a diagram depicts software elements of a computer program 400 for programming a special processor in a communication system for providing a special processing of a communication sent from a first user processor at a first location to a second user processor at a second location across a communication network, the second user processor having an address in a special address range assigned to user processors in the second location that require the special processing. The computer program comprises a first software element 402 for programming the special processor to receive the communication addressed to the second user processor. The computer program further comprises a second software element 404 for programming the special processor to perform the special processing on the communication, in response to receiving the communication addressed to the second user processor, and to perform one of encapsulating and re-addressing the communication, and then to routinely deliver the communication to a second special processor, the second special processor having an address that is not in the special address range.

The computer program 400 further comprises a third software element 406 for programming the special processor to receive a specially-processed communication addressed to the special processor, and, in response, to perform an inverse of the special processing, and to re-address the communication for routine delivery to the second user processor.

In addition, the computer program 400 includes a fourth software element 408 for programming the special processor to apply an exception during a cross-address situation in which a user processor that does not require the special processing makes an attempt to communicate across the communication network with another user processor that does require the special processing, the exception selected from a group of exceptions consisting of: (a) rejecting the attempt to communicate; (b) transparently tunneling the attempt to communicate, without the special processing; and (c) non-transparently connecting the attempt to communicate.

Referring to FIG. 5, a diagram depicting software elements of a computer program 500 for programming a router in a communication system for providing a special processing of a communication sent from a first user processor at a first location to a second user processor at a second location across a communication network, the second user processor having an address in a special address range assigned to user processors in the second location that require the special processing. The computer program comprises a first software element 502 for statically programming the router at the first location to route the communication to a first special processor, in response to the address of the second user processor being in the special address range.

In one embodiment, the first location includes a plurality of special processors, and the second location includes a plurality of groups of user processors requiring special processing, the plurality of groups having addresses in a corresponding plurality of special-ranges. In that embodiment, the first software element 502 programs the router to route a message addressed to a user processor in one of the plurality of groups to one of the plurality of special processors assigned to handle the one of the plurality of groups.

In another embodiment, the communication system includes a third location having a third user processor having its address in a second special address range assigned to user processors in the third location that require the special processing, and the first location includes first and second special processors. In this embodiment, the first software element 502 programs the router to route to the first special processor all messages addressed to the second user processor in the second location, and further programs the router to route to the second special processor all messages addressed to the third user processor in the third location.

The computer program 500 further comprises a second software element 504 for programming the router to route all communications from the first user processor to another user processor in the first location, such that no special processor is involved in the communications.

In addition, the computer program 500 includes a third software element 506 for programming the router to route all communications from the first user processor to another user processor in the second location whose address is outside the special address range, such that no special processor is involved in the communications.

Thus, it should be clear from the preceding disclosure that the present invention provides a method and computer programs for providing special processing of traffic across a communication network. The method and computer programs advantageously provide reliable special processing of selected traffic without requiring all traffic to pass through the special processors and without incurring the other disadvantages of the prior-art methods. One of ordinary skill in the art will recognize the techniques disclosed herein are general and can be implemented with many degrees of freedom. For example, the first and second embodiments 100, 200 are depicted as having three separate locations, all using internet protocol (IP) addressing. One of ordinary skill in the art will recognize that the present invention can be applied to communication systems having virtually any number of separate locations and using other types of addressing as well.

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiments were chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled.

1. A method in a communication system for providing a special processing of a communication sent from a first user processor at a first location to a second user processor at a second location across a communication network, the second user processor having an address in a special address range assigned to user processors in the second location that require the special processing, the method comprising:
programming a router at the first location to route the communication to a first special processor, in response to the address of the second user processor being in the special address range;
programming the first special processor to perform the special processing on the communication addressed to the second user processor and to perform one of encapsulating and re-addressing the communication to send the communication to a second special processor, the second special processor having an address that is not in the special address range, thereby allowing routine delivery of the communication to the second special processor.

2. The method of claim 1, further comprising:
programming the second special processor to receive the communication addressed to the second special processor, and, in response, to perform an inverse of the special processing, and to re-address the communication for routine delivery to the second user processor.

3. The method of claim 1, further comprising:
designating any user processors at the second location that require the special processing when receiving communications; and
assigning addresses in the special address range to the user processors that require the special processing.

4. The method of claim 1, further comprising:
designating any user processors at the second location that do not require the special processing when receiving communications; and
assigning addresses outside the special address range to the user processors that do not require the special processing and to all special processors of the second location.

5. The method of claim 1,
wherein the first location includes a plurality of ingress/egress routers, and
wherein the method further comprises coupling the plurality of ingress/egress routers directly to the first special processor, and
wherein programming the router comprises programming the plurality of ingress/egress routers to route the communication to the first special processor, in response to the address of the second user processor being in the special address range.

6. The method of claim 1,
wherein the first location includes a plurality of special processors, and
wherein the second location includes a plurality of groups of user processors requiring special processing, the plurality of groups having addresses in a corresponding plurality of special-ranges, and
wherein programming the router comprises programming the router to route a message addressed to a user processor in one of the plurality of groups to one of the plurality of special processors assigned to handle the one of the plurality of groups.

7. The method of claim 1,
wherein the communication system includes a third location having a third user processor having its address in a second special address range assigned to user processors in the third location that require the special processing, and
wherein the first location includes first and second special processors, and
wherein programming the router comprises programming the router to route to the first special processor all messages addressed to the second user processor in the second location, and further comprises programming the router to route to the second special processor all messages addressed to the third user processor in the third location.

8. The method of claim 1, wherein programming the router comprises programming a static route to the first special processor.

9. The method of claim 1, wherein programming the router comprises automatically programming, by the first special processor through a routing protocol, a route to the first special processor.

10. The method of claim 1, wherein programming the router comprises
programming the router to route all communications from the first user processor to another user processor in the first location, such that no special processor is involved in the communications.

11. The method of claim 1, wherein programming the router comprises
programming the router to route all communications from the first user processor to another user processor in the second location whose address is outside the special address range, such that no special processor is involved in the communications.

12. The method of claim 1, further comprising
applying an exception during a cross-address situation in which a user processor that does not require the special processing makes an attempt to communicate across the communication network with another user processor that does require the special processing, the exception selected from a group of exceptions consisting of:
rejecting the attempt to communicate;
transparently tunneling the attempt to communicate, without the special processing; and
non-transparently connecting the attempt to communicate.

13. A computer program for programming a special processor in a communication system for providing a special processing of a communication sent from a first user processor at a first location to a second user processor at a second location across a communication network, the second user processor having an address in a special address range assigned to user processors in the second location that require the special processing, the computer program comprising:
a first software element for programming the special processor to receive the communication addressed to the second user processor; and
a second software element 404 for programming the special processor to perform the special processing on the communication, in response to receiving the communication addressed to the second user processor, and to perform one of encapsulating and re-addressing the communication, and then to routinely deliver the communication to a second special processor, the second special processor having an address that is not in the special address range.

14. The computer program of claim 13, further comprising
a third software element for programming the special processor to receive a specially-processed communication addressed to the special processor, and, in response, to perform an inverse of the special processing, and to re-address the communication for routine delivery to the second user processor.

15. The computer program of claim 13, further comprising a fourth software element for programming the special processor to apply an exception during a cross-address situation in which a user processor that does not require the special processing makes an attempt to communicate across the communication network with another user processor that does require the special processing, the exception selected from a group of exceptions consisting of:
rejecting the attempt to communicate;
transparently tunneling the attempt to communicate, without the special processing; and
non-transparently connecting the attempt to communicate.

16. A computer program for programming a router in a communication system for providing a special processing of a communication sent from a first user processor at a first location to a second user processor at a second location across a communication network, the second user processor having an address in a special address range assigned to user processors in the second location that require the special processing, the computer program comprising:
a first software element for programming the router at the first location to route the communication to a first special processor, in response to the address of the second user processor being in the special address range.

17. The computer program of claim 16,
wherein the first location includes a plurality of special processors, and
wherein the second location includes a plurality of groups of user processors requiring special processing, the plurality of groups having addresses in a corresponding plurality of special-ranges, and
wherein the first software element further programs the router to route a message addressed to a user processor in one of the plurality of groups to one of the plurality of special processors assigned to handle the one of the plurality of groups.

18. The computer program of claim 16,
wherein the communication system includes a third location having a third user processor having its address in a second special address range assigned to user processors in the third location that require the special processing, and
wherein the first location includes first and second special processors, and
wherein the first software element further programs the router to route to the second special processor all messages addressed to the third user processor in the third location.

19. The computer program of claim 16, wherein the first software element further programs a static routing to the first special processor.

20. The computer program of claim 16, further comprising
a second software element for programming the router to route all communications from the first user processor to another user processor in the first location, such that no special processor is involved in the communications.

21. The computer program of claim 16, further comprising
a third software element for programming the router to route all communications from the first user processor to another user processor in the second location whose address is outside the special address range, such that no special processor is involved in the communications.
